(19) United States
(12) Patent Application Publication
(10) Pub. No.: US 2015/0348296 A1
(43) Pub. Date: Dec. 3, 2015

(54) User Interface for Displaying Data

(71) Applicant: Kyvos Insights, Inc., Los Gatos, CA (US)

(72) Inventors: Leigh Chapman, Victoria BC (CA); Pratik Jain, Indore (IN); Dharmendra Chauhan, Indore (IN); Kavindra Singh, Indore (IN)

(21) Appl. No.: 14/612,609

(22) Filed: Feb. 3, 2015

Related U.S. Application Data
(60) Provisional application No. 62/004,964, filed on May 30, 2014.

(51) Int. Cl. G06T 11/20

(52) U.S. Cl. CPC G06T 11/206; G06T 11/203

(57) ABSTRACT

System and method for processing and displaying data on a user interface is disclosed. At first, data is received in a hierarchy comprising a first level data, a second level data, and a third level data. After receiving the data, first vertical bars representing the first level data is displayed. From the first vertical bars, a first vertical bar is selected to display second vertical bars representing the second level data. Upon displaying the second vertical bars, a second vertical bar from the second vertical bars is selected to display third vertical bars representing the third level data.

### CROSS REFERENCE TO RELATED APPLICATIONS

The present application claims priority to a Provisional Patent Application No. U.S. 62/004,964 filed on May 30, 2014, the entirety of which is hereby incorporated by reference.

### TECHNICAL FIELD

The present disclosure in general relates to user interfaces. More particularly, the present disclosure relates to a system and method for dynamically processing and displaying data in hierarchy on a user interface.

### BACKGROUND

Menu tree is generally used on a user interface for displaying hierarchical data to users of computers/data processing devices. In order to access and view the data in an effective manner, the data may be arranged in a hierarchical manner, generally, using a tree hierarchy or a menu tree showing multiple levels within. The tree hierarchy or menu tree of the data may provide organization and structure to the data. In the tree hierarchy or the menu tree, the data may be broken down or drilled down into several categories and subcategories that may be relevant for a particular data type. Typically, the menu tree may display a parent level/parent icon at a root level. Further, the parent level comprises a child level/child icon indicating a leaf level displayed below the root level. In addition, each of the leaf level may further comprise sub-child levels indicating the broken down/drilled down levels depending on the data. In order to display the menu tree, conventional techniques require entire data to be retrieved prior to generating the menu trees. Further, conventional menu trees are generated statically after entire data is gathered for such menu trees.

When a user accesses the computer for the data, the user may be presented with a view of the menu tree and also a view of contents/elements of the data that are currently selected in the menu tree. The user may access/navigate the view of the menu tree by expanding and/or contracting the contents/elements within the menu tree based upon their requirement.

Conventional menu trees generally contain description of the data at each level of data, i.e., at parent level, child level, sub-child level, and so on. Therefore, convention menu trees generally require considerable space on a screen/display of the computer and do not leave space for the information corresponding to the menu tree elements.

### SUMMARY

This summary is provided to introduce concepts related to systems and methods for processing and displaying data on a user interface and the concepts are further described below in the detailed description. This summary is not intended to identify essential features of the claimed subject matter nor is it intended for use in determining or limiting the scope of the claimed subject matter.

In one implementation, a method for processing and displaying data on a user interface is disclosed. The method comprises receiving, by a processor, data from a source. The data is received in a hierarchy comprising a first level data, a second level data, and a third level data. The method further comprises displaying, by the processor, first vertical bars representing the first level data. The method further comprises selecting, by the processor, a first vertical bar from the first vertical bars to display second vertical bars representing the second level data. The method further comprises selecting, by the processor, a second vertical bar from the second vertical bars to display third vertical bars representing the third level data.

In one implementation, a system for processing and displaying data on a user interface is disclosed. The system comprises a processor and a memory coupled to the processor. The processor is capable of executing program instructions stored in the memory. The processor executes the program instructions to receive data from a source. The data is received in a hierarchy comprising a first level data, a second level data, and a third level data. The processor further executes the program instructions to display first vertical bars representing the first level data. The processor further executes the program instructions to select a first vertical bar from the first vertical bars to display second vertical bars representing the second level data. The processor further executes the program instructions to select a second vertical bar from the second vertical bars to display third vertical bars representing the third level data.

In one implementation, a non-transitory computer readable medium embodying a program executable in a computing device for processing and displaying data on a user interface is disclosed. The program comprises a program code for receiving data from a source. The data is received in a hierarchy comprising a first level data, a second level data, and a third level data. The program further comprises a program code for displaying first vertical bars representing the first level data. The program further comprises a program code for selecting a first vertical bar from the first vertical bars to display second vertical bars representing the second level data. The program further comprises a program code for selecting a second vertical bar from the second vertical bars to display third vertical bars representing the third level data.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like/similar features and components.

FIG. 1 illustrates a network implementation of a system for processing data and displaying data on a user interface, in accordance with an embodiment of the present disclosure.

FIG. 2 illustrates the system, in accordance with an embodiment of the present disclosure.

FIG. 3A, FIG. 3B, and FIG. 3C illustrate a plurality of vertical bars in a hierarchy, in accordance with an embodiment of the present disclosure.

FIG. 4 illustrates a selection of the vertical bars to generate a graph of filtered data, in accordance with an embodiment of the present disclosure.

FIG. 5 shows a flowchart of a method for processing and displaying data on a user interface, in accordance with an embodiment of the present disclosure.

### DETAILED DESCRIPTION

The present disclosure relates to a system and a method for processing and displaying the data on a user interface. At first, the data may be received from a source. The source may be a user-defined source and/or an external database. The data may be received in a hierarchy comprising a first level data, a second level data and a third level data. The hierarchy may be represented using a plurality of vertical bars on the user interface. Specifically, first vertical bars representing the first level data may be displayed on the user interface. A first vertical bar from the first vertical bars may be selected to display second vertical bars representing the second level data. The first level data comprising the second level data may be processed dynamically to display the second vertical bars. When the first vertical bar is selected, the first vertical bar may be visually modified to a color, a thickness, a length, and a shape different from remaining first vertical bars. Subsequently, the first level data corresponding to the selection of the first vertical bar may be displayed in a graphical form or a text form.

After the second vertical bars are displayed, a second vertical bar from the second vertical bars may be selected to display third vertical bars representing the third level data. The second level data comprising the third level data may be processed dynamically to display the third vertical bars. When the second vertical bar is selected, the second vertical bar may be visually modified to a color, a thickness, a length, and a shape different from remaining second vertical bars. Subsequently, the second level data corresponding to the selection of the second vertical bar may be displayed in a graphical form or a text form

While aspects of described system and method for processing and displaying data on a user interface may be implemented in any number of different computing systems, environments, and/or configurations, the embodiments are described in the context of the following exemplary system.

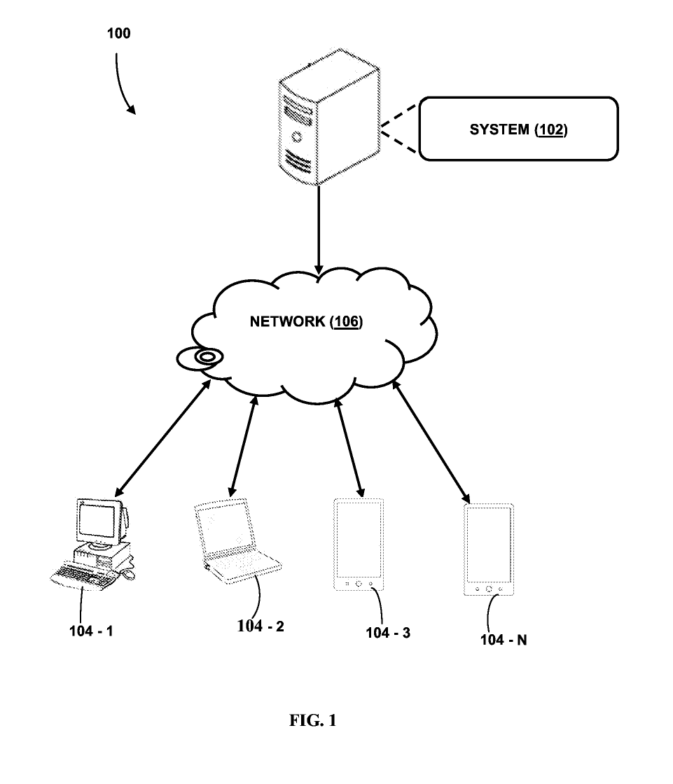

Referring now to FIG. 1, a network implementation 100 of a system 102 for processing and displaying data on a user interface is illustrated, in accordance with an embodiment of the present disclosure. The system 102 may receive data from a source. The data may be received in a hierarchy comprising a first level data, a second level data, and a third level data. After receiving the data, the system 102 may display first vertical bars representing the first level data. Upon displaying the first vertical bars, the system 102 may select a first vertical bar from the first vertical bars to display second vertical bars representing the second level data. Subsequently, the system 102 select a second vertical bar from the second vertical bars to display third vertical bars representing the third level data.

Although the present disclosure is explained by considering that the system 102 is implemented as a software application on a server, it may be understood that the system 102 may also be implemented in a variety of computing systems, such as a laptop computer, a desktop computer, a notebook, a workstation, a mainframe computer, a server, a network server, cloud, and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

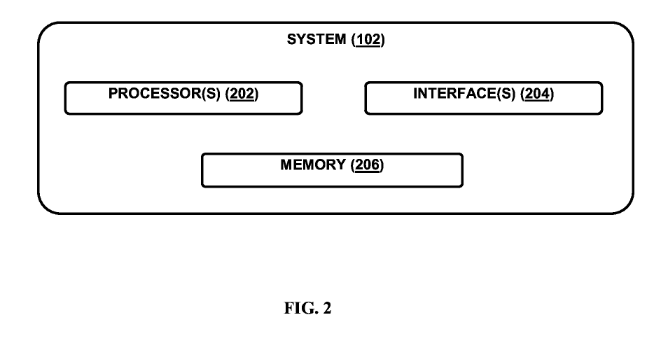

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

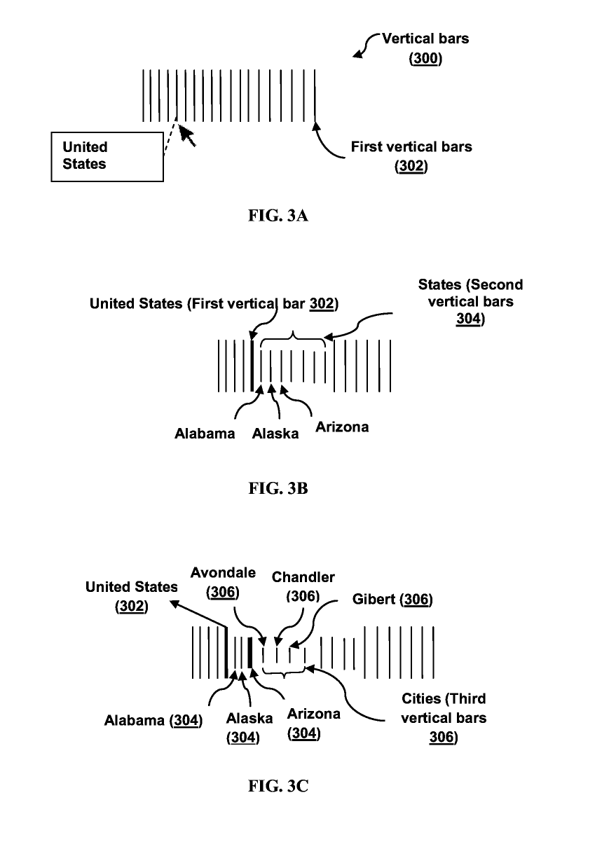

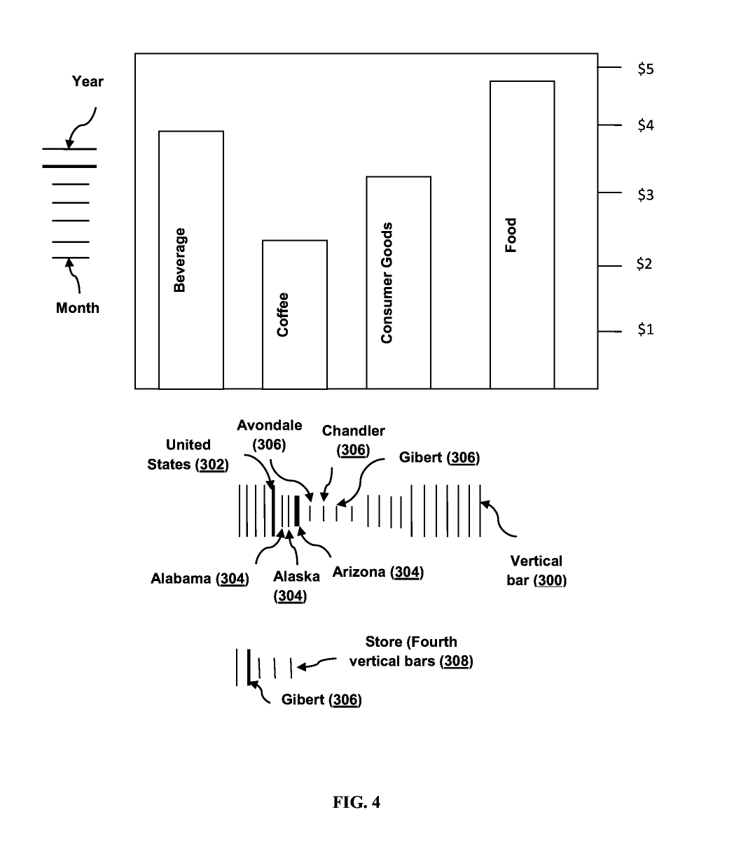

In one implementation, at first, the user may use the client device 104 to access the system 102 via the I/O interface 204. The working of the system 102 may be explained in detail using FIG. 2, FIG. 3A, FIG. 3B, FIG. 3C, and FIG. 4. The system 102 may be used to process and display data on the user interface 204. In order to process the data, the system 102 may receive the data from a source. The source may be a user-defined source or an external database (not shown). In one example, the external database may include a telecom database storing call records. In another example, the external database may include a database storing information of products sold in a particular store. Examples of the data may include call records in telecom industry, or sales information of a product in several geographies, or patients' information in hospitals, or population count in several geographies and the like. For the present disclosure, the data may be considered to be the sales information of a product in several countries. The sales information may correspond to a number of products sold in the countries, states, cities, towns, areas, and so on. Although, the following description is explained using the sales information as the data, however, it must be understood that the present invention may be used to process and display the data of any kind/nature.

The system 102 may receive the data in a hierarchy comprising a first level data, a second level data, and a third level data. Each level may correspond to the data in the hierarchy. Upon receiving the data, the system 102 may process the data to generate a plurality of vertical bars 300 as shown in FIG. 3A. In one embodiment, the system 102 may process the data dynamically to generate first vertical bars 302 representing the first level data. The first vertical bars 302 generated may be displayed on the user interface 204 as shown in FIG. 3A. Considering the data to be sales information about products in several geographies, a list of countries such as India, Australia, and United States may be represented as the first vertical bars 302 in the vertical bars 300 shown in FIG. 3A such that each first vertical bar represents a country. When the user hovers over the first vertical bar 302 using a cursor, the first vertical bar 302 may be annotated with a name of a country to which the first vertical bar 302 corresponds, as shown in FIG. 3A. Specifically, FIG. 3A shows hovering a cursor over the first vertical bar 302 representing United States. In one example, the countries may be displayed in an alphabetical order in the first vertical bars 302. In another example, the countries may be displayed based on the size of geographical area in Square Miles. The system 102 may process the data dynamically to generate and display the first vertical bars 302 corresponding to the first level data. It must be noted that since the first vertical bars 302 are generated dynamically, the system 102 does not require the entire data to be gathered at one instance. The system 102 may gather the data as and when the data is received and dynamically (on the go) process the data into the first vertical bars 302. In other words, the system 102 may keep on expanding or filling the first vertical bars 302 with the data dynamically till the data keeps coming to the system 102.

Referring now to FIG. 3B, when the first vertical bars 302 are displayed on the user interface 204, the user may select or click on a first vertical bar 302 from the first vertical bars 302 present in the vertical bars 300. In one example, the user may select the first vertical bar 302 by tapping/touching on the user interface 204. In another example, the user may select the first vertical bar 302 by double clicking a particular first vertical bar 302 on the user interface 204. When the first vertical bar 302 is selected, the first vertical bar 302 may be visually modified. The first vertical bar 302 selected may be visually modified to a color, a thickness, a length, and a shape different from remaining first vertical bars 302. For example, if the color of the first vertical bars 302 is displayed in a red color, upon selecting a first vertical bar 302, color of the first vertical bar 302 selected may be modified to a blue color. After the first vertical bar 302 is selected, the first vertical bar 302 may be expanded to display information within the first level data. Specifically, the first vertical bars 302 may be expanded to display second vertical bars 304 representing the second level data. For example, when the user selects or clicks a first vertical bar 302 representing a country such as United States, then all the states within United States may be displayed on the user interface 204 as the second vertical bars 304, thereby expanding the vertical bars 300 as shown in FIG. 3B. The second vertical bars 304 may represent states such as Alabama, Alaska, and Arizona within the United States. In one implementation, the second vertical bars 304 may have a smaller height than the first vertical bars 302 representing the countries. In another implementation, the second vertical bars 304 may have a different color or shape or thickness or fill or opaqueness from the first vertical bars 302 representing the countries. The shape may include, but not limited to, geometric shapes such as a circle, a square, a rectangle, and a triangle. When the second vertical bars 304 representing the states of a particular country is displayed on the user interface 204, the user may hover over the second vertical bars 304 to know the name of the states being represented by each second vertical bar 304. The hovering of a cursor by the user over the second vertical bar 304 may display a name of a state represented by each second vertical bar 304. For example, the user may hover over the second vertical bar 304 representing Arizona. After hovering, the name of the state Arizona may be displayed. The system 102 may process the data dynamically to generate and display the second vertical bars 304 corresponding to the second level data. Further, the system 102 may gather the data as and when the data is received and dynamically process the data into the second vertical bars 304.

Referring now to FIG. 3C, the user may similarly select or click on a particular second vertical bar 304 to learn about cities present in a particular state. After selecting the second vertical bar 304, third vertical bars 306 representing the third level data may be displayed. The third vertical bars 306 may be displayed by expanding the vertical bars 300 displayed on the user interface 204. In the example discussed above, if the user has selected the second vertical bar 304 indicating the state Arizona, the system 102 may display the third vertical bars 306 indicating the cities present in Arizona. The cities Avondale, Chandler, Gilbert and the like present in Arizona may be displayed as the third vertical bars 306 as shown in FIG. 3C. When the third vertical bars 306 representing the cities of a particular state is displayed on the user interface 204, the user may hover over the third vertical bars 306 to know the name of the city being represented by each third vertical bar 306. The hovering of a cursor by the user over the third vertical bar 306 may display a name of a city represented by each second vertical bar 304. For example, the user may hover over the third vertical bar 306 representing Chandler. After hovering, the name of the city Chandler may be displayed. The system 102 may process the data dynamically to generate and display the third vertical bars 306 corresponding to the third level data. Further, the system 102 may gather the data as and when the data is received and dynamically process the data into the third vertical bars 306.

Similarly the data may be drilled down to a plurality of levels as desired by the user. The vertical bars 300 may be processed in such a way that each first vertical bar 302 has some information at a first level; each second vertical bar 304 has some information at a second-level; each third vertical bar 306 has some information at a third-level, and so on.

It may be understood that the vertical bars 300 may be color coded. For example, The first vertical bars 302 representing the first level data may be depicted with red colour; the second vertical bars 304 may be depicted with blue colour; the third vertical bars 306 may be depicted with green colour; and so on. Similarly, the thickness of the first vertical bars 302 representing the first level data may be 0.2 mm; the thickness of the second vertical bars 304 may be 0.4 mm; the thickness of the third vertical bars 306 may be 0.6 mm; and so on. As discussed above, upon selecting the first vertical bars 302 by a user, the thickness of the first vertical bar 302 selected may be increased to 1 mm. Similarly, the thickness of the second vertical bars 304 and the third vertical bars 306 upon selection may be increased to 1.5 mm and 2 mm respectively. Similarly, the height of the first vertical bars 302, the second vertical bars 304, and the third vertical bars 306 may vary upon selection. It is apparent that any representation of the vertical bars 300 may be adapted for the purpose of this disclosure and is within the intent of the present disclosure.

Although the above example is used to explain the drilling down of the data using a vertical bar 300, an aspect of processing the data in a reverse direction may also be achieved using the system 102. For example, consider that the data is captured for a certain merchandize such as shoes, clothes, mobile phones, and the like. In this example, the first level data may be the merchandize, i.e., each first vertical bar 302 may represent a merchandize. Further, the second level data may be shoe brands, or clothing brands, or mobile phone brands, and the like. For the second level data, the second vertical bars 304 may be used to represent the shoe brands, or clothing brands, or mobile phone brands. Further, at the third level data of the hierarchy, the system 102 may display shoes, clothes, or mobile phone of only that brand selected in the second vertical bars 304. After displaying the data in different levels, the system 102 may select a second vertical bar 304 representing a shoe brand to display the vertical bars representing shoes. Subsequently, the system 102 may select a second vertical bar 304 representing a clothing brand to display the vertical bars representing clothes. In order to display the data corresponding to the selection, the system 102 processes the data dynamically and presents the data on the user interface 204. Therefore, it must be understood that the disclosure may be used for filtering and processing the data in any direction.

In one implementation, the system 102 may display the first level data upon selection of the first vertical bar 302. The system 102 may display the first level data in a graphical form or a text form. Similarly, the system 102 may display the second level data upon selection of the second vertical bar 304. The system 102 may display the second level data in a graphical form or a text form. Similarly, the data in the hierarchy may be displayed upon selection of the vertical bar in the corresponding level. In order to explain the displaying of the data, FIG. 4 may be used as an example. Referring to FIG. 4, the data comprising the sales information of several products in several geographies is represented on a graph using several vertical bars. Consider the hierarchy of the sales information for a country->state->city; and year->month for given commodities such as food, beverage, coffee, consumer goods in a particular store of the city. In other words, in order to generate a graph for a particular city in a particular country for a particular store in a particular month, the user may select the appropriate vertical bars in the hierarchy. For the example discussed, each city representing the third level data may comprise fourth level data represented by fourth vertical bars 308 corresponding to the stores. In other words, the fourth level data may comprise information about stores in the city. In order to display the fourth level data using the fourth vertical bars 308, the user may select a store within the city. Upon selecting a fourth vertical bar 308, the sales information of the products in the store may be displayed as shown in FIG. 4. Specifically, FIG. 4 shows two vertical bars on an x-axis and one vertical bar on a y-axis of the graph. The vertical bars on the x-axis may represent a geographical location in the hierarchy of country->state->city->store. The vertical bar on the y-axis may represent time in the year as the first vertical bars. The year may comprise months as second vertical bars in the hierarchy.

In the present example, the sales information for the commodities within a price range of $1-$5 in the store may be processed using the vertical bars. The year in the first vertical bars and a month in the second vertical bars may be received as an input from the user. Similarly, for each first vertical bar, the second vertical bar, the third vertical bar, and the fourth vertical bar in the hierarchy i.e., country->state->city->store may be received as an input on the vertical bar representing geographical location. Based on the selection on the vertical bars, the data corresponding to each selection may be processed/retrieved and displayed in form of a graph shown in FIG. 4. In one example, the data processed may be shown in a form of a bar graph or a pie chart. In another example, the data processed/retrieved may be shown in a text form. For example, if the data relates to population of the geographical location, upon selecting the vertical bar of a state or the city, the population count may be displayed in the text form. It must be understood that a graph or a pie chart or any other visual representation of the data may be generated using several vertical bars to obtain the desired data.

Although the present disclosure is explained considering vertical bars representing data in multiple levels, horizontal bars representing the data may be used to present the data in multiple levels. In one embodiment, the data may be represented using a combination of vertical bars and the horizontal bars. For example, the first level data may be represented by the vertical bars, the second level data may be represented by the horizontal bars, and the third level data may be represented by the vertical bars and so on. In another embodiment, the data may be represented using other representations; e.g., a silhouette of country shape may be used to represent the first level data. Similarly, a silhouette of state shape may be used to represent the second level data. In another embodiment, the data may be represented using geometric shapes such as a circle, a square, a triangle, etc. For example, the first level data may be represented using circles. The second level data may be represented circles having a different size from the circles representing the first level data. In another example the first level data may be represented by the circle, the second level data may be represented by the square, and the third level data may be represented by the rectangle and so on.

By displaying the data in multiple levels with different representation, the system 102 may enable the user to identify the data in a particular level with ease. Further, the system 102 may dynamically process the data and update the data in the multiple levels.

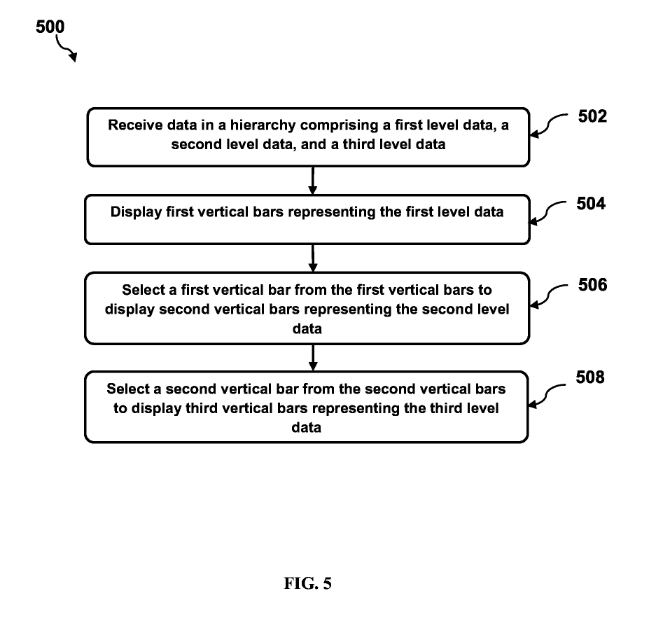

Referring now to FIG. 5, a method 500 for processing and displaying data in multiple levels on a user interface is shown, in accordance with an embodiment of the present disclosure. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described and is not intended to be construed as a limitation, and any number of the described method blocks can be combined in any order to implement the method 500 or alternate methods. Additionally, individual blocks may be deleted from the method 500 without departing from the spirit and scope of the disclosure described herein. Furthermore, the method may be implemented in any suitable hardware, software, firmware, or combination thereof. However, for ease of explanation, in the embodiments described below, the method 500 may be implemented in the above-described system 102.

At step/block 502, the data may be received from a source. The data may be received in a hierarchy comprising a first level data, a second level data, and a third level data.

At step/block 504, first vertical bars representing the first level data may be displayed.

At step/block 506, a first vertical bar from the first vertical bars may be selected to display second vertical bars representing the second level data.

At step/block 508, a second vertical bar from the second vertical bars may be selected to display third vertical bars representing the third level data.

Although implementations of system and method for processing data and displaying/presenting the data on the user interface have been described in language specific to structural features and/or methods, it is to be understood that the appended claims are not necessarily limited to the specific features or methods described. Rather, the specific features and methods are disclosed as examples of implementations for displaying/presenting the data in a hierarchy on a user interface.

1. A method for processing and displaying data on a user interface, the method comprising:
receiving, by a processor, data from a source, wherein the data is received in a hierarchy comprising a first level data, a second level data, and a third level data;
displaying, by the processor, first vertical bars representing the first level data;
selecting, by the processor, a first vertical bar from the first vertical bars to display second vertical bars representing the second level data; and
selecting, by the processor, a second vertical bar from the second vertical bars to display third vertical bars representing the third level data.

2. The method of claim 1, wherein the source is one of a user-defined source and an external database.

3. The method of claim 1, further comprising visually modifying the first vertical bar upon selection.

4. The method of claim 1, further comprising visually modifying the second vertical bar upon selection.

5. The method of claim 3, wherein the first vertical bar is visually modified to a color, a thickness, a length, and a shape different from remaining first vertical bars.

6. The method of claim 4, wherein the second vertical bar is visually modified to a color, a thickness, a length, and a shape different from remaining second vertical bars.

7. The method of claim 1, further comprising displaying the first level data upon selecting the first vertical bar in a graphical form or a text form.

8. The method of claim 1, further comprising displaying the second level data upon selecting the second vertical bar in a graphical form or a text form.

9. The method of claim 1, further comprising processing the data dynamically to display the first vertical bars, the second vertical bars and the third vertical bars.

10. The method of claim 1, further comprising hovering over the first vertical bar to display annotation of the first level data.

11. The method of claim 1, further comprising hovering over the second vertical bar to display annotation of the second level data.

12. A system for processing and displaying data on a user interface, the system comprising:
a processor; and
a memory coupled to the processor, wherein the processor is capable of executing program instructions stored in the memory, to:
receive data from a source, wherein the data is received in a hierarchy comprising a first level data, a second level data, and a third level data;
display first vertical bars representing the first level data;
select a first vertical bar from the first vertical bars to display second vertical bars representing the second level data; and
select a second vertical bar from the second vertical bars to display third vertical bars representing the third level data.

13. The system of claim 12, wherein the source is one of a user-defined source and an external database.

14. The system of claim 12, wherein the processor further executes the program instructions to visually modify the first vertical bar upon selection.

15. The system of claim 12, wherein the processor further executes the program instructions to visually modify the second vertical bar upon selection.

16. The system of claim 14, wherein the first vertical bar is visually modified to a color, a thickness, a length, and a shape different from remaining first vertical bars.

17. The system of claim 15, wherein the second vertical bar is visually modified to a color, a thickness, a length, and a shape different from remaining second vertical bars.

18. The system of claim 12, wherein the processor further executes the program instructions to display the first level data upon selecting the first vertical bar in a graphical form or a text form.

19. The system of claim 12, wherein the processor further executes the program instructions to display the second level data upon selecting the second vertical bar in a graphical form or a text form.

20. A non-transitory computer readable medium embodying a program executable in a computing device for processing and displaying data on a user interface, the program comprising:
a program code for receiving data from a source, wherein the data is received in a hierarchy comprising a first level data, a second level data, and a third level data;
a program code for displaying first vertical bars representing the first level data;
a program code for selecting a first vertical bar from the first vertical bars to display second vertical bars representing the second level data; and
a program code for selecting a second vertical bar from the second vertical bars to display third vertical bars representing the third level data.
